(19) United States
(12) Patent Application Publication
(10) Pub. No.: US 2011/0113919 A1
(43) Pub. Date: May 19, 2011

(54) TABLE SYSTEM

(75) Inventors: CHEN-HSING CHENG, Tu-Cheng (TW); HSING-YI HU, Tu-Cheng (TW)

(73) Assignee: HON HAI PRECISION INDUSTRY CO., LTD., Tu-Cheng (TW)

(21) Appl. No.: 12/722,783

(22) Filed: Mar. 12, 2010

(30) Foreign Application Priority Data
Nov. 16, 2009 (TW) 98138793

(51) Int. Cl. B23Q 1/44; G05G 11/00; B23Q 1/48

(52) U.S. Cl. 74/490.08

(57) ABSTRACT

A table system includes a moving table, first and second guide rails extending along a linear path, a first slider positioned between the moving table and the first guide rail including a first revolving assembly, a second slider positioned between the moving table and the second guide rail including a second revolving assembly and a sliding assembly slidably connected to the second revolving assembly, first and second linear actuators to move the first and second sliders. The moving table is rotatably connected to the first guide rail by the first revolving assembly; the sliding assembly is rotatably connected to the second guide rail by the second revolving assembly, and the sliding assembly is slidably connected to the moving table. The first and second linear actuators are selectively actuated to control the movement of the moving table along linear and curved paths.

### BACKGROUND

1. Technical Field

The present disclosure relates to table systems, and more particularly, to a table system can move along linear and curved paths.

2. Description of the Related Art

Referring to FIG. 9, a typical table system 10 employed in a double housing planer includes a pair of parallel guide rails 11, 12, a moving table 14, two sliders 15, 16, and two linear actuators 17, 18. The sliders 15 and 16 are slidably mounted on the guide rails 11 and 12, and two sides of the moving table 14 are fixed to the sliders 15, 16. The linear actuators 17 and 18 are actuated to drive the sliders 15, 16 respectively, thus moving the moving table 14 and the sliders 15, 16. As the two linear actuators 17, 18 are synchronously actuated, the moving table 14 can move along a linear path. However, when a curved motion of the moving table 14 is required, a rotation actuator is employed. The rotation actuator and the two linear actuators 17, 18 cooperatively move the moving table 14 along linear and curved paths, thus the structure and control of the table system 10 are complex.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view of an embodiment of a table system including a first slider and a second slider.

FIG. 2 is an exploded isometric view of the table system of FIG. 1.

FIG. 3 is an isometric view of the first slider of the table system of FIG. 1, the first slider including a first revolving assembly.

FIG. 4 is an exploded isometric view of the first revolving assembly in FIG. 3.

FIG. 5 is a cross-section of the first revolving assembly, taken along the line V-V shown in FIG. 3.

FIG. 6 is an isometric view of the second slider of the table system of FIG. 1.

FIG. 7 is an exploded, isometric view of the second slider of FIG. 6, but with a bottom plate of the second slider removed.

FIG. 8 is a cross-section of the second slider, taking along the line VIII-VIII shown in FIG. 6.

FIG. 9 is an isometric view of a typical table system.

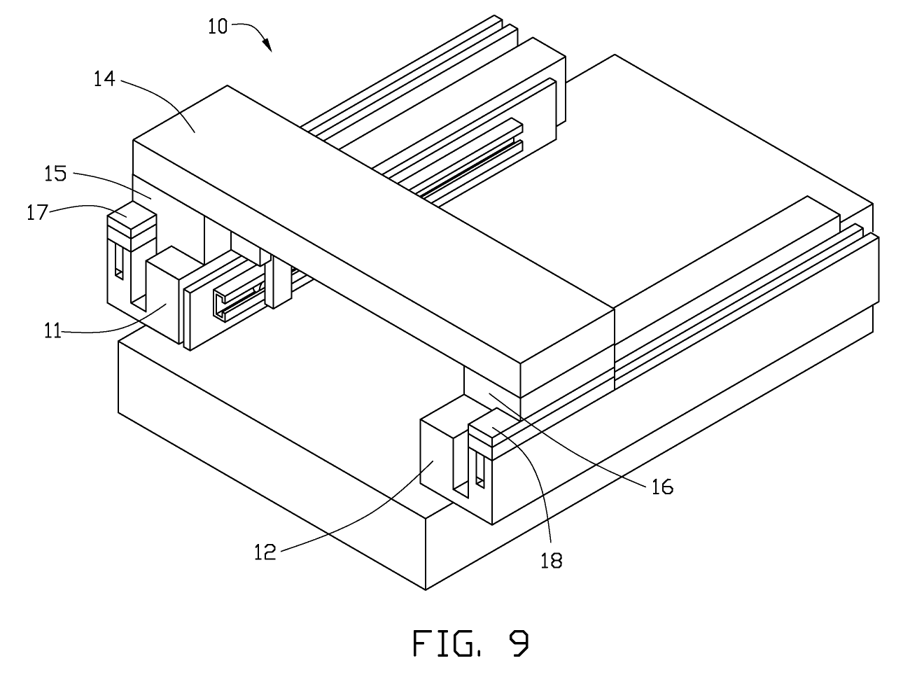

### DETAILED DESCRIPTION

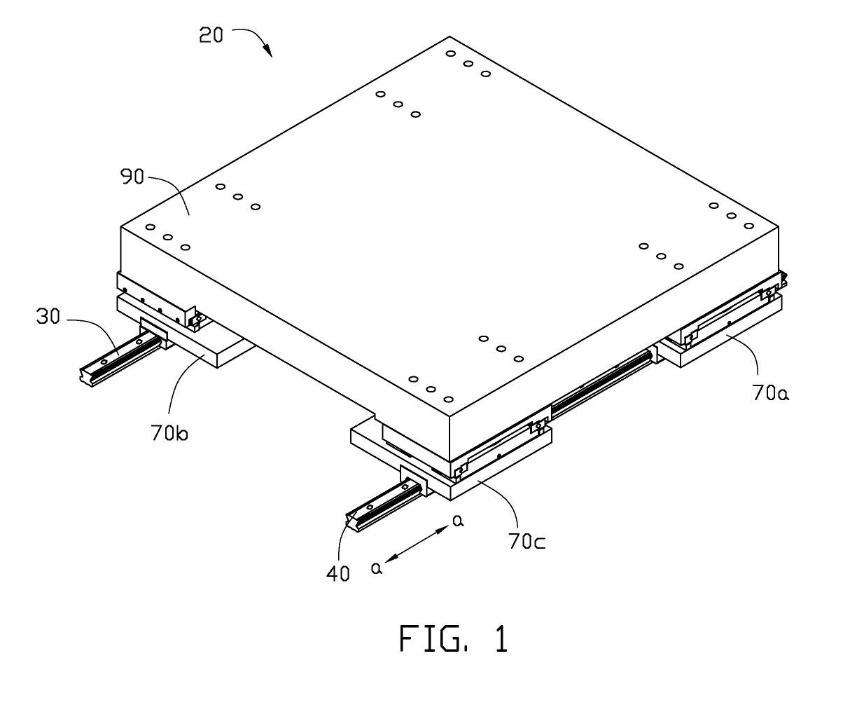

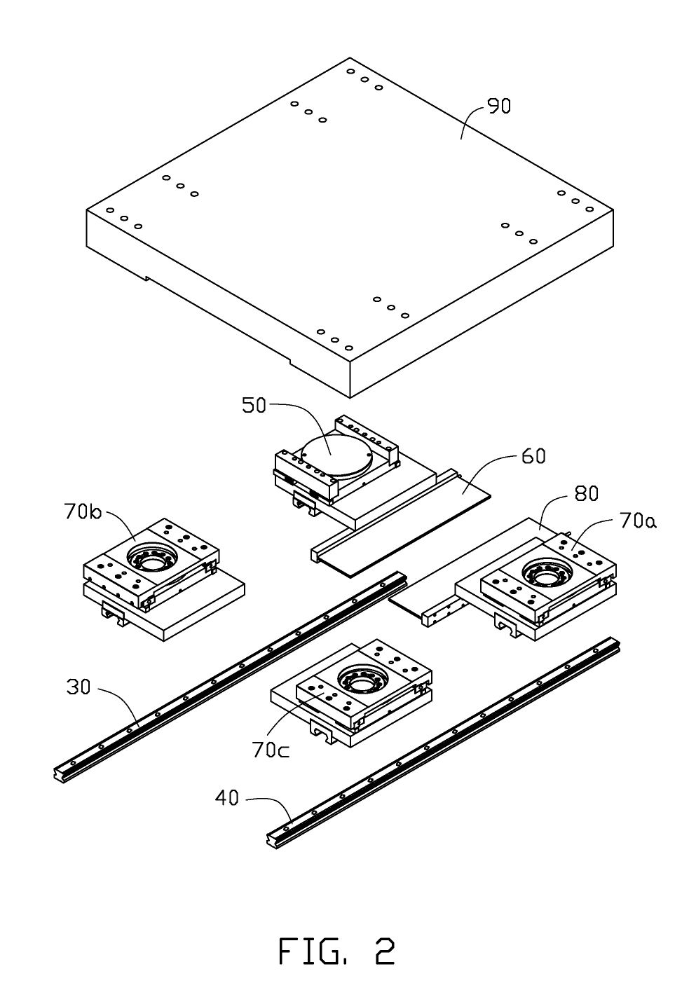

Referring to FIGS. 1 and 2, an embodiment of a table system 20 includes a first guide rail 30 extending along a linear path a-a, a second guide rail 40 substantially parallel to the first guide rail 30, a first slider 50 slidably connected to the first guide rail 30, a first linear actuator 60 moving the first slider 50 along the first guide rail 30, a second slider 70a slidably connected to the second guide rail 40, a second linear actuator 80 moving the second slider 70a along the second guide rail 40, and a moving table 90 having opposite ends connected to the first and second sliders 50, 70a, respectively. The moving table 90 is capable of moving along the linear path a-a and a curved path.

In the illustrated embodiment, the moving table 90 is a substantially rectangular block. The table system 20 further includes two second sliders 70b, 70c slidably connected to the first and second guide rails 30, 40, respectively. The first slider 50 and these three second sliders 70a, 70b and 70c are located at the four corners of the moving table 90, respectively.

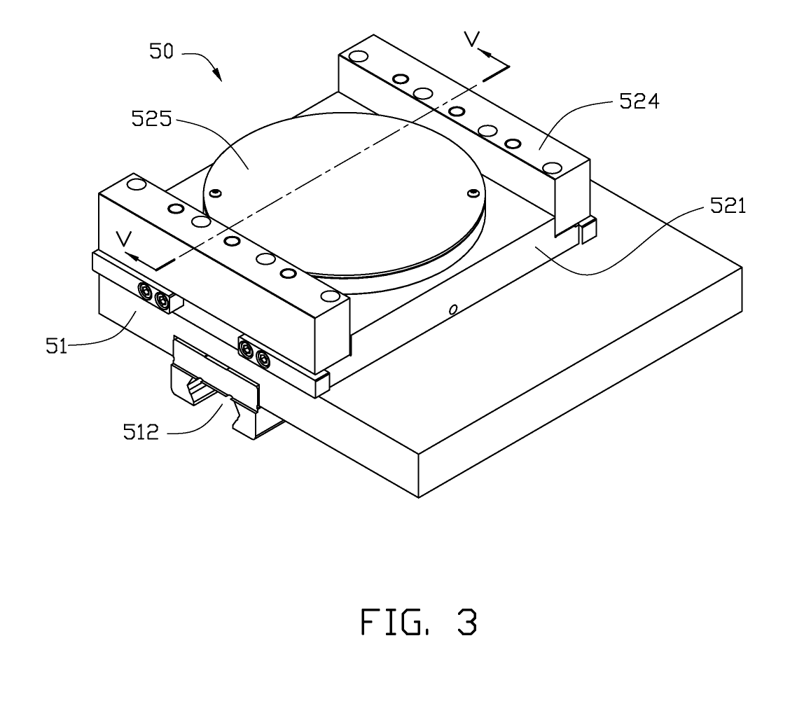

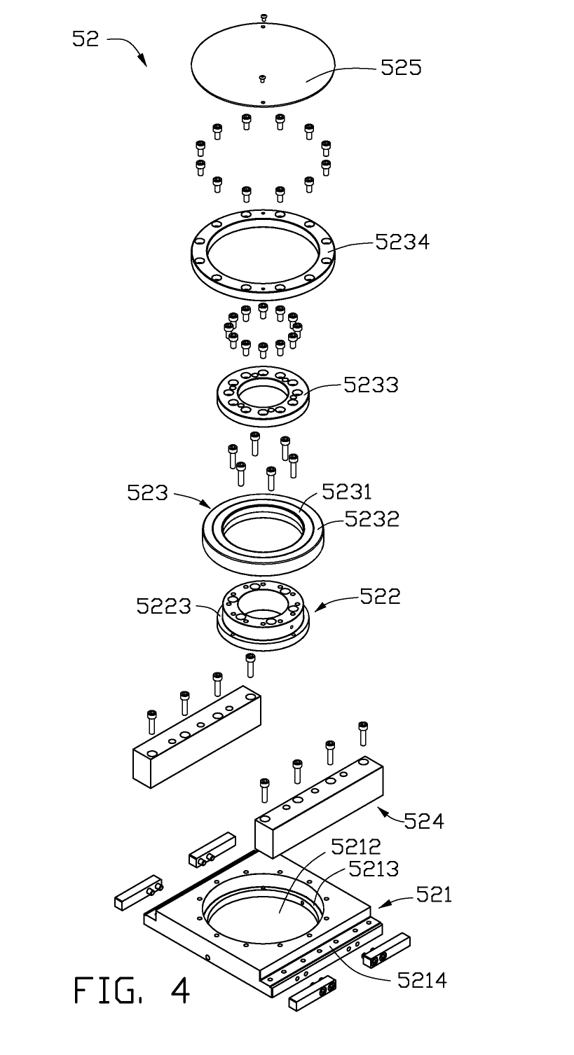

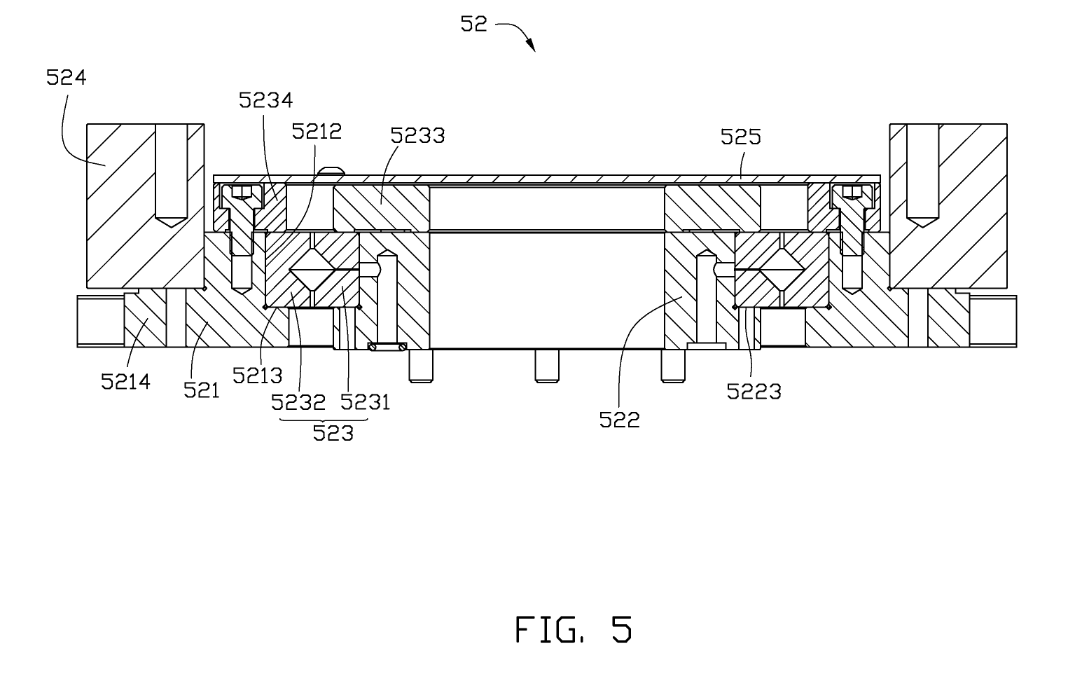

Referring to FIGS. 3 through 5, the first slider 50 includes a first bottom plate 51 and a first revolving assembly 52 connected to the first bottom plate 51. The first bottom plate 51 defines a slot 512 in a bottom surface thereof and is slidably connected to the first guide rail 30 via the slot 512.

The first revolving assembly 52 includes a first revolving plate 521, a first base body 522, a first revolving bearing 523, and two connection plates 524.

The first revolving plate 521 defines a through hole 5212 in the center region thereof. A protrusion 5213 is formed on the inner surface of the through hole 5212. Two flanges 5214 are formed on opposite sides of the first revolving plate 521. Here, each connection plate 524 is fixed to a corresponding flange 5214 by fastening, although it should be understood that the connection plate 524 and the first revolving plate 521 may be integrally formed.

The first base body 522 is substantially cylindrical and received in the through hole 5212 of the first revolving plate 521. The first base body 522 includes a flange 5223 extending radially from the outer surface of the first base body 522.

The first revolving bearing 523 includes a first inner ring 5231, a first outer ring 5232 and a plurality of first balls (not labeled). The first inner ring 5231 fits in the first outer ring 5232, and the first balls are held between the first inner ring 5231 and the first outer ring 5232, thus the first outer ring 5232 can smoothly revolve relative to the first inner ring 5231. A first inner fixing plate 5233 is placed on the first inner ring 5231 and fastened to the first base body 522, such that the first inner ring 5231 is secured to the flange 5223 of the first base body 522. A first outer fixing plate 5234 is placed on the first outer ring 5232 and fastened to the first revolving plate 52, such that the first outer ring 5232 is secured to the flange 5213 of the first revolving plate 5211. The first base body 522 is fixed to the first bottom plate 51 and the two connection plates 524 are fixed to the moving table 90, such that the moving table 90 is capable of moving along a curved path relative to the first bottom plate 51 around a rotation axis of the first revolving plate 521.

Furthermore, the revolving assembly 52 may include a dust-protection cover 525 on the first outer fixing plate 5234 to prevent contaminants from entering the first revolving bearing 523.

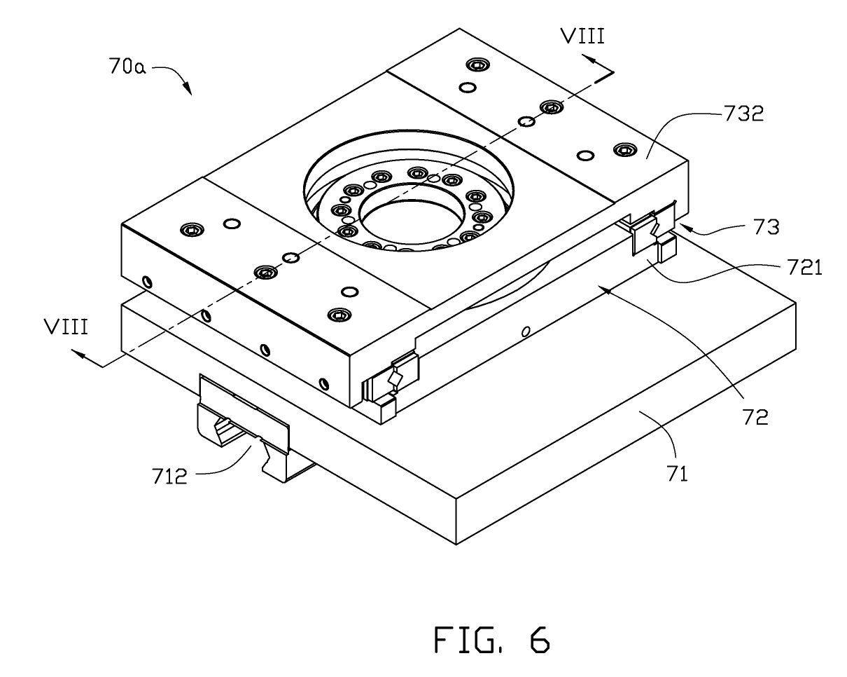

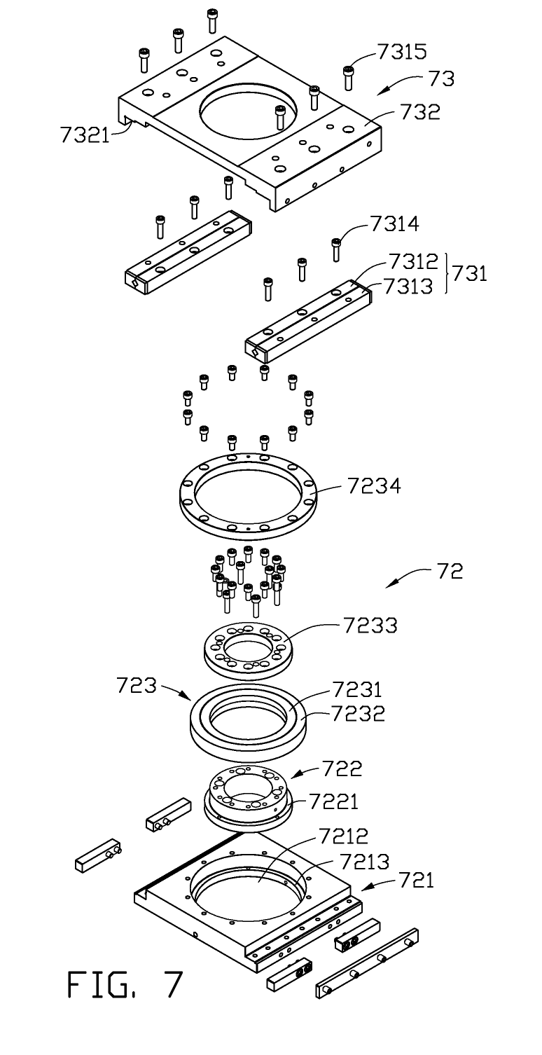

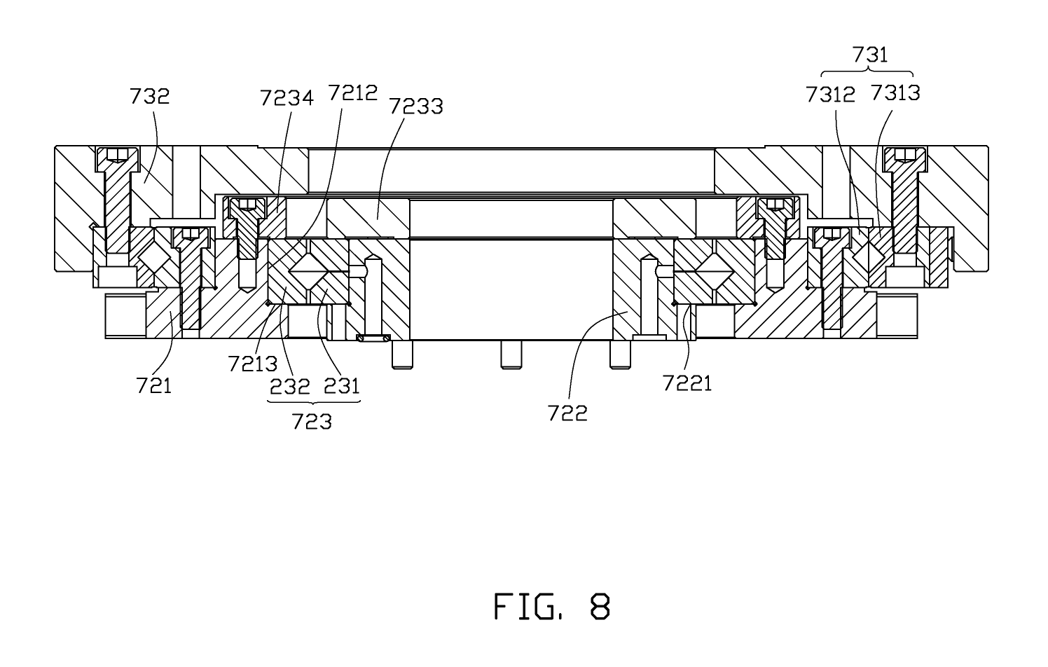

Referring to FIGS. 6 through 8, the second slider 70a includes a second bottom plate 71, a second revolving assembly 73, and a sliding assembly 73. A slot 712 is defined in a bottom surface of the second bottom plate 71. The second bottom plate 71 is slidably connected to the second guide rail 40 via the slot 712. These second sliders 70a, 70b and 70c may be equivalent in structure.

The second revolving assembly includes a second revolving plate 721, a second base body 722, and a second revolving bearing 723.

The second revolving plate 721 defines a through hole 7212 in the center region thereof. A protrusion 7213 is formed on the inner surface of the through hole 7212. The second base body 722 is received in the through hole 7212. The second base body 722 includes a flange 7221 extending radially from the outer surface of the second base body 722.

The second revolving bearing 723 includes a second inner ring 7231, a second outer ring 7232, and a plurality of second balls (not labeled). The second inner ring 7231 fits in the second outer ring 7232, and the second balls are held between the second inner ring 7231 and the second outer ring 7232, such that the second outer ring 7232 can smoothly revolve relative to the second inner ring 7231. The second inner ring 7231 is mounted on the flange 7221 of the second base body 722, with a second inner fixing plate 7233 fastened to the second base body 722. The second outer ring 7232 is mounted on the flange 7213 of the second revolving plate 721, with a second outer fixing plate 7234 fastened to the second revolving plate 721. The second base body 722 is fixed to the second bottom plate 71, such that the second revolving plate 721 is capable of freely revolving relative to the second bottom plate 71.

The sliding assembly 73 includes two sliding bearings 731 and a slidable plate 732. A slot 7321 is defined in a bottom surface of the slidable plate 732. The slidable plate 732 is slidably connected to the second revolving plate 721 via the slot 7321.

Each sliding bearing 731 includes an inner bar 7312, an outer bar 7313, and a plurality of balls (not labeled) between the inner bar 7312 and the outer bar 7313, such that the inner bar 7312 can smoothly slide along the outer bar 7313. The inner bar 7312 is fixed to the second revolving plate 721 by a first plurality of fasteners 7314. The outer bar 7313 is fixed to the sliding bar 732 by a plurality of second fasteners 7315, such that the slidable plate 732 is capable of sliding along the second revolving plate 721. The slidable plate 732 is also capable of rotating together with the second revolving plate 7221 as the second revolving plate 7221 rotates. The slidable plate 732 is fixed to the moving table 90.

The first and second linear actuators 60, 80 can be installed on sides of the first guide rail 30 and the second guide rail 40 respectively. The first and second linear actuators 60, 80 respectively move the first and second sliders 50, 70a along the linear path a-a.

In the table system 20, the first and second linear actuators 60, 80 are selectively actuated to control not only the amount of movement but also a path thereof for the moving table 90. The moving table 90 is moved to along the linear path a-a as the first and second linear actuators 60, 80 are synchronously actuated. Otherwise, the moving table 90 is revolved around a revolving axis of the first revolving plate 521 as the first and second linear actuators 60, 80 are asynchronously actuated, and the rotation angle of the moving table 90 is determined by the difference displacement between the first slider 50 and the second slider 70a. Therefore, the moving table 90 can be moved towards a desired location in the linear path a-a and revolving angle relative to the first guide rail 30.

In the embodiment disclosed, the moving table 90 of the table system 20 is capable of moving along a linear path a-a and a curved path by selectively actuating the first and second linear actuators 60, 80 with no rotation driving means. Thus, the position of the table system 20 can be easily controlled and the table system 20 presents a compact and simplified construction.

It is believed that the present embodiments and their advantages will be understood from the foregoing description, and it will be apparent that various changes may be made thereto without departing from the spirit and scope of the embodiments or sacrificing all of its material advantages, the examples hereinbefore descried merely being preferred or exemplary embodiments.

What is claimed is:

1. A table system comprising:
a moving table;
a first guide rail extending along a linear path;
a second guide rail substantially parallel to the first guide rail;
a first slider positioned between the moving table and the first guide rail and comprising a first revolving assembly;
a second slider positioned between the moving table and the second guide rail and comprising a second revolving assembly and a sliding assembly slidably connected to the second revolving assembly;
a first linear actuator to move the first slider along the linear path; and
a second linear actuator to move the second slider along the linear path; wherein the moving table is rotatably connected to the first guide rail via the first revolving assembly;
the sliding assembly is rotatably connected to the second guide rail via the second revolving assembly, and the sliding assembly is slidably connected to the moving table.

2. The table system of claim 1, wherein the first slider further comprises a first bottom plate connected to the first revolving assembly, the bottom plate defining a slot slidably connected to the first guide rail.

3. The table system of claim 2, wherein the first revolving assembly comprises a first revolving plate, a first base body rotatably positioned in the revolving plate, and a first revolving bearing positioned between the first revolving plate and the first base body.

4. The table system of claim 3, wherein the first revolving plate is fixed to the moving table and the first base body is fixed to the first bottom plate.

5. The table system of claim 3, wherein the first revolving bearing comprises a first inner ring, a first outer ring and a plurality of first balls; the first inner ring fits in the first outer ring and the first balls are held between the first inner ring and the first outer ring.

6. The table system of claim 5, wherein the first inner ring is secured to the first base body and the first outer ring is secured to the first revolving plate.

7. The table system of claim 3, wherein the first revolving assembly further comprises a dust cover.

8. The table system of claim 1, wherein the second slider further comprises a second bottom plate connected to the second revolving assembly, and the second bottom plate defines a slot slidably connecting to the second guide rail.

9. The table system of claim 8, wherein the second assembly comprises a second revolving plate, a second base body rotatably positioned in the second revolving plate, and a second revolving bearing positioned between the second revolving plate and the second base body.

10. The table system of claim 9, wherein the second base body is fixed to the second bottom plate and the second revolving plate is fixed to the sliding assembly.

11. The table system of claim 8, wherein the second revolving bearing comprises a second inner ring, a second outer ring and a plurality of second balls; the second inner ring is received in the second outer ring, and the second balls are held between the second inner ring and the second outer ring.

12. The table system of claim 11, wherein the second inner ring is secured to the second base body and the second outer ring is secured to the sliding assembly.

13. The table system of claim 9, wherein the sliding assembly comprises a slidable plate slidably connected to the second revolving plate and at least one sliding bearing between the second revolving and the slidable plate.

14. The table system of claim 13, wherein the at least one sliding bearing comprises an inner bar, an outer bar, and a plurality of balls between the inner bar and the outer bar.

15. The table system of claim 14, wherein the inner bar is fixed to the second revolving plate and the outer bar is fixed to the slidable plate.

16. A table system comprising:
a moving table;
a first guide rail extending along a linear path;
a second guide rail substantially parallel to the first guide rail;
a first slider positioned between the moving table and the first guide rail and comprising a first revolving assembly;
a second slider positioned between the moving table and the second guide rail and comprising a second revolving assembly and a sliding assembly slidably connected to the second revolving assembly;
a first linear actuator for moving the first slider along the linear path; and
a second linear actuator for moving the second slider along the linear path; wherein the moving table is rotatably connected to the first guide rail by the first revolving assembly; the sliding assembly is rotatably connected to the second guide rail by the second revolving assembly, and the sliding assembly is slidably connected to the moving table; the first and second linear actuators are selectively actuated to control movement of the moving table along linear and curved paths.

17. A table system comprising:
a moving table;
a first guide rail extending along a linear path;
a second guide rail substantially parallel to the first guide rail;
a first slider positioned between the moving table and the first guide rail and comprising a first revolving assembly;
three second sliders, each of which comprises a second revolving assembly and a sliding assembly slidably connected to the second revolving assembly, one of the three second sliders mounted on the first guide rail and the others on the second guide rail;
a first linear actuator for moving the first slider to along the linear path; and
a second linear actuator for moving one of the second sliders mounted on the second guide rail along the linear path, wherein the first revolving assembly and the sliding assemblies are connected to the moving table, and the first and second linear actuators are selectively actuated to control the movement of the moving table along linear and curved paths.

18. The table system of claim 17, wherein the table is a substantially rectangular block, and the first slider and the three sliders are substantially located at the four corners of the moving table respectively.
